(19) United States
(12) Patent Application Publication
(10) Pub. No.: US 2007/0080319 A1
(43) Pub. Date: Apr. 12, 2007

(54) Rust preventive for magnesium and/or magnesium alloy

(76) Inventors: Kazunori Fukumura, TOKUSHIMA-SHI (JP); Yuhua Yu, Tokushima (JP); Masaya Kajimoto, Tokushima (JP); Hiroshi Hama, Tokushima (JP); Takashi Hamauzu, Tokushima (JP); Hiroshi Yagi, Tokushima (JP)

Correspondence Address: KUBOVCIK & KUBOVCIK, SUITE 710, 900 17TH STREET NW, WASHINGTON, DC, 20006, US

(21) Appl. No.: 10/578,920

(22) PCT Filed: Nov. 10, 2003
(86) PCT No.: PCT/JP03/14244

§ 371 Date: Aug. 15, 2006

(51) Int. Cl. C09K 5/00

(52) U.S. Cl. 252/75

(57) ABSTRACT

A corrosion inhibitor for magnesium and/or magnesium alloy containing, as an effective component, a least one kind of compound selected from the group consisting of a compound of the formula (1) and a compound of the formula (2) and salts thereof, and a process for producing components or parts made of magnesium and/or magnesium alloy using the corrosion inhibitor 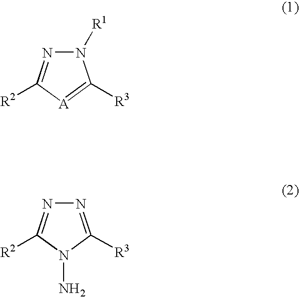
wherein R¹ is a hydrogen atom, or C₁₋₄ alkyl, R² is a hydrogen atom, C₁₋₄ alkyl, mercapto or hydroxy, R³ is a hydrogen atom, C₁₋₄ alkyl or hydroxy, A is —N═ or —C(R⁴)═, R⁴ is a hydrogen atom or amino.

### TECHNICAL FIELD

The present invention relates to a corrosion inhibitor for magnesium and/or magnesium alloy and to a process for producing components or parts made of magnesium and/or magnesium alloy using the corrosion inhibitor.

### BACKGROUND ART

Magnesium is the most lightweight of all the metals for use as practically useful structural materials, has a high specific strength, is easy to machine and therefore has found wide use for motor vehicle components, electric products such as computers and acoustic devices, aircraft components, etc. Generally, magnesium and magnesium alloys are made into shaped articles mainly by die casting, extrusion or rolling, while the so-called thixomolding process with use of an injection molding machine has been established technically in recent years. This process assures the freedom of shape of moldings, the productivity thereof and improved properties, rendering the moldings useful for wider application.

However, magnesium is the basest of all the metals for use as practically useful structural materials, therefore has the drawback of being susceptible to oxidation and needs to be inhibited from corroding as an important problem.

Generally a triazole compound is known as a corrosion inhibitor for metals. For example, JP-B-1377/1977 discloses 4H-1,2,4-triazole compound as a volatile corrosion inhibitor for various metals containing magnesium. On the other hand, JP-A-65680/1993 describes that 1,2,3- and 1,2,4-triazole compounds are effective as a corrosion inhibitor for zinc- and zinc-type surface-treated steel plates.

The present inventors discovered that aromatic carboxylic acid and a salt thereof are effective as a corrosion inhibitor for magnesium and/or magnesium alloy, and that when aromatic carboxylic acid and a salt thereof are used in combination with a triazole compound and/or pyrazole compound, the corrosion inhibitory effect is improved (as set forth in e.g. Patent literature 1).

[Patent literature 1] WO 00/40777

However, it was also found that when aromatic carboxylic acid and a salt thereof are used in combination with a triazole compound and/or pyrazole compound, the coating adhesiveness is insufficient. The 4H-1,2,4-triazole compound described in JP-B-1377/1977 has an insufficient corrosion inhibitory effect against magnesium, and compounds other than a specific triazole can not exhibit a satisfactory corrosion inhibitory effect against magnesium and/or magnesium alloy.

An object of the invention is to provide a corrosion inhibitor which has a high corrosion inhibitory effect against magnesium and/or magnesium alloy and which is excellent in coating adhesiveness, and a process for producing components or parts made of magnesium and/or magnesium alloy using the corrosion inhibitor.

### DISCLOSURE OF THE INVENTION

The invention provides a corrosion inhibitor for magnesium and/or magnesium alloy, the corrosion inhibitor containing, as an effective component, a least one kind of compound selected from the group consisting of a compound of the formula (1) and a compound of the formula (2) and salts thereof 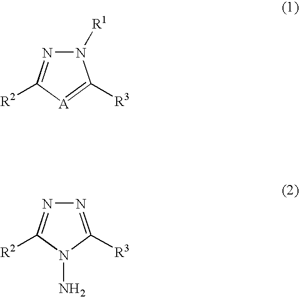
wherein R¹ is a hydrogen atom, or C₁₋₄ alkyl, R² is a hydrogen atom, C₁₋₄ alkyl, mercapto or hydroxy, R³ is a hydrogen atom, C₁₋₄ alkyl or hydroxy, A is —N═ or —C(R⁴)═, R⁴ is a hydrogen atom or amino.

The present invention provides a process for preparing a treated magnesium and/or magnesium alloy component, the process comprising (A) treating a magnesium and/or magnesium alloy component with a surface-treating agent, and (C) treating the component with a corrosion inhibitor for magnesium, wherein the above-mentioned corrosion inhibitor is used as such corrosion inhibitor.

Further the present invention provides a process for preparing a treated magnesium and/or magnesium alloy component, the process comprising (A) treating the magnesium and/or magnesium alloy component with a surface-treating agent, (B) treating the component with a pre-treating agent used before a corrosion inhibition treatment and (C) treating the component with a corrosion inhibitor for magnesium, wherein the above-mentioned corrosion inhibitor is used as such corrosion inhibitor.

Moreover, the present invention provides a process for preparing a treated magnesium and/or magnesium alloy component wherein the step of treatment with a corrosion inhibitor for magnesium is repeated at least twice.

The present invention also provides a process for preparing a treated magnesium and/or magnesium alloy component, wherein a step of washing with water is added in a next step of each of at least one step of (A), (B) and (C).

Furthermore, the present invention provides a process for preparing a treated magnesium and/or magnesium alloy component, the process comprising (1) deburring the magnesium and/or magnesium alloy component when required, (2) treating the component with a surface-treating agent, (2-1) washing with water, (3) treating the component with a pre-treating agent used before a corrosion inhibition treatment, (3-1) washing with water, (4) treating the component with a corrosion inhibitor for magnesium, (4-1) washing with water, (5) drying the component, (6) coating or plating the component, and (7) thereafter assembling the component, wherein the above-mentioned corrosion inhibitor is used as the foregoing corrosion inhibitor for magnesium.

The present invention further provides a process for preparing the above-mentioned magnesium and/or magnesium alloy component, wherein the step of treatment with a corrosion inhibitor for magnesium is repeated at least twice.

The present inventors additionally discovered that when the foregoing aromatic carboxylic acid and a salt thereof are used in combination with a triazole-type compound and/or pyrazole-type compound, the aromatic carboxylic acid and a salt thereof are responsible for reduction in coating adhesiveness. The other discovery is that a compound alone selected from a certain kind of triazole-type compound and pyrazole-type compound can exhibit a corrosion inhibitory effect as high as or higher than the aromatic carboxylic acid and a salt thereof. Based on this novel finding, the present invention was accomplished.

The corrosion inhibitor of the invention for magnesium and/or magnesium alloy contains, as an effective component, a least one kind of compound selected from the group consisting of a compound of the formulas (1) and (2), and salts thereof.

In the specification, the C₁₋₄ alkyl refers to straight-chain or branched chain alkyl groups having 1 to 4 carbon atoms and includes, for example, methyl, ethyl, n-propyl, isopropyl, n-butyl, isobutyl, sec-butyl and tert-butyl.

Examples of the compound of the formula (1) are 1,2,4-triazole compounds wherein A is —N═, and pyrazole compounds wherein A is —C(R⁴)═. The compound of the formula (2) includes 1,2,4-triazole compounds.

Examples of such 1,2,4-trizole compound are 3-hydroxy-1,2,4-triazole, 3-mercapto-1,2,4-triazole, 3-mercapo-l-methyl-1,2,4-triazole, 3-mercapto-l-ethyl-1,2,4-triazole, 3-mercapto-1-isopropyl-1,2,4-triazole, and 4-amino-1,2,4-triazole. These triazole compounds can be used either alone or in combination. Usable as salts of these triazole compounds are salts of such compounds with various organic bases and inorganic bases.

Examples of organic bases are monoethanolamine, diethanolamine, triethanolamine, monoisopropanolamine, diisopropanolamine, triisopropanolamine and like alkanolamines, methylamine, ethylamine, cyclohexylamine, ethylenediamine, 1,3-bis(aminomethyl)cyclohexane and like aliphatic amines, 1-aminopyrrolidine, morpholine, DBU(1,8-diazabicyclo[5.4.0]-7-undecene), DBN(1,5-diazabicyclo[4.3.0]-5-nonene) and like cyclic amines.

Examples of inorganic bases are sodium hydroxide, potassium hydroxide, lithium hydroxide and like alkali metal hydroxides, ammonia and hydrazine. One of such salts is usable singly, or at least two of them are usable conjointly.

Among these salts, alkanolamine, alkali metal hydroxides and hydrazine are preferable.

The triazole compounds to be used in the invention are generally acidic substances having a pH of about 3. Thus, the amount of these bases to be used is adjusted to a substantially neutral range.

Preferred examples of the triazole compound and a salt thereof to be used herein are 3-mercapto-1,2,4-triazole, alkanolamine salt, alkali metal salt, and hydrazine salt thereof.

Useful pyrazole compounds are, for example, 3,5-dimethylpyrazole, 3,5-diethylpyrazole, 3-methyl-5-hydroxypyrazole, 3-ethyl-5-hydroxypyrazole, 3-isopropyl-5-hydroxypyrazole, and 4-aminopyrazole. These pyrazole compounds can be used either alone or in combination.

The corrosion inhibitor of the invention can be used by itself or is preferably used in the form of a solution in a suitable solvent. Specific examples of the solvent are water, methanol, ethanol, n-propanol, isopropanol, n-butanol, sec-butanol, tert-butanol, isobutanol, n-pentanol, ethyl cellosolve, butyl cellosolve, 1-methoxy-2-propanol, ethylene glycol, propylene glycol, diethylene glycol, polyethylene glycol, polypropylene glycol and like alcohols, ethyl acetate, propyl acetate, butyl acetate and like esters, petroleum ether, hexane, heptane and like aliphatic hydrocarbons, benzene, toluene, xylene and like aromatic hydrocarbons, acetone, methyl ethyl ketone, methyl isobutyl ketone and like ketones, diethyl ether, dibutyl ether, tetrahydrofuran, dioxane and like ethers, N,N-dimethylformamide and like amides and mixtures thereof. Preferably these solvents are used in the form of an aqueous solution in consideration of costs, operators' safety, waste water disposal and the like. In this case, the amount of triazole compound or pyrazole compound to be used can be suitably determined. Usually the amount is 0.001 to 10 wt %, preferably 0.01 to 5 wt %, more preferably 0.05 to 1 wt % in total amount based on the solution.

The corrosion inhibitor of the invention may contain other corrosion inhibitors for magnesium. However, when it is used in combination with tert-butyl benzoic acid, toluic acid or like aromatic carboxylic acids or salts thereof, the coating adhesiveness is lowered. Hence their combined use is undesirable.

The magnesium or magnesium alloy for which the corrosion inhibitor of the present invention is usable is not limited specifically. The composition is usable for magnesium as a single metal and a wide variety of alloys or composite materials comprising magnesium and other metals. Examples of other metals are aluminum, zinc, manganese, iron, nickel, copper, lead, tin and calcium. One or at least two metals can be selected from among these metals for use.

In view of convenience of transport, preferably the corrosion inhibitor of the invention is provided as a solid or a concentrate and is used as dissolved in or diluted with water to the specified concentration.

In treatment with the corrosion inhibitor of the invention, a solution of the corrosion inhibitor is applied with a spray or a roll coater to the surface of ingots, chips or molded articles of magnesium or magnesium alloy, or they may be immersed in the solution. The corrosion inhibitor of the invention is used at a temperature of 0 to about 90° C., preferably about 5 to about 80° C., most preferably about 10 to about 70° C. In this step, a surfactant or like additives may be added to the corrosion inhibitor to an extent which does not impair the intended effect. A supersonic wave treatment may be performed.

Known surfactants can be used. Nonionic and amphoteric surfactants are preferably used, and cationic surfactant is also usable.

Nonionic surfactant is not specifically limited and includes for example polyoxyethylene alkyl ethers such as polyoxyethylene lauryl ether and polyoxyethylene higher alcohol ether, polyoxyethylene alkylphenyl ethers such as polyoxyethylene octylphenyl ether, polyoxyethylene glycol fatty acid esters such as polyoxyethylene monostearate, sorbitan fatty acid esters such as sorbitan monolaurate and polyoxyethylene sorbitan monolaurate, glycol fatty acid esters such as glycol monostearate and fatty acid monoglyceride. Among these preferable are polyoxyethylene alkyl ethers and polyoxyethylene alkylphenyl ethers, and particularly preferable are those having HLB value of 13 to 15.

Amphoteric surfactant is not specifically limited and includes for example aminocarboxylic acids such as alkyl β-aminopropionic acids, alkyl β-iminodipropionic acids and β-aminopropionic acid, and betaines such as trimethylglycine. Among these preferable are β-aminopropionic acid and betaines.

Cationic surfactant is not also specifically limited and includes for example aliphatic amine hydrohalides, alkyl pyridinium halides and quaternary ammonium salts. Among these preferable are aliphatic amine hydrohalides and quaternary ammonium salts.

The above surfactant can be used singly or in combination of at least two of them at the same time. The amount of the surfactant can be used singly or in combination of at least two of them at the same time. The amount of the surfactant is usually about 0.0001 to about 50 wt. %, preferably about 0.001 to about 10 wt. % in the total of the composition.

The amount of the corrosion inhibitor of the invention to be used is not limited and may be a level sufficient to uniformly coat the surface of an article with the corrosion inhibitor.

When the surface of a molded article molded by a thixomolding method or die casting method is treated by use of the corrosion inhibitor of the invention, the molded article can be transported or stored in a pre-coated state for a long term, significantly contributing to rationalization of the producing process. That is, the molded article of magnesium or magnesium alloy molded by a thixomolding method or a die casting method (hot chamber die casting method and cold chamber die casting method) so rapidly undergoes corrosion on the surface that the molded article conventionally required either taking a coating step immediately after molding or taking a step of removing the corrosion inhibitor prior to coating after treatment with the corrosion inhibitor. When a molded article is surface-treated with the corrosion inhibitor of the invention, the surface-treated molded article may be directly coated without being adversely affected, eliminating the need for removing the corrosion inhibitor as done heretofore.

The coating film formed by coating the molded article after treatment with the corrosion inhibitor of the invention is excellent in adhesion to the surface of the molded article of magnesium and is markedly suitable for use on the surface of a molded article of magnesium and/or magnesium alloy which needs coating.

In use of the corrosion inhibitor of the invention, the surface of a molded article to be treated is preferably degreased before treatment with the corrosion inhibitor in order to improve the corrosion inhibitory effect. The degreasing treatment steps include conventional degreasing treatments as with a solvent, alkali, emulsion or acid. These degreasing treatments can be conducted singly or in combination.

According to the invention, a treated magnesium and/or magnesium alloy component can be produced by, after the above-mentioned degreasing treatment, subjecting the component to surface treatment, treatment with a pre-treating agent used before a corrosion inhibition treatment, and treatment with a corrosion inhibitor. The corrosion inhibition treatment may be done once, but when done twice or more times, can preferably achieve a higher corrosion inhibitory effect.

Preferred processes for producing magnesium and/or magnesium alloy component treated with the corrosion inhibitor of the invention include those in which the corrosion inhibitor of the invention is used as a corrosion inhibitor for magnesium in a process similar to the process disclosed in WO 01/83849.

Namely, in a process for preparing a treated magnesium and/or magnesium alloy component comprising (A) treating a magnesium and/or magnesium alloy component with a surface-treating agent, and (C) treating the component with a corrosion inhibitor for magnesium, the present corrosion inhibitor is particularly preferably used as the corrosion inhibitor of the step (C).

Further, in a process for preparing a treated magnesium and/or magnesium alloy component comprising (A) treating the magnesium and/or magnesium alloy component with a surface-treating agent, (B) treating the component with a pre-treating agent used before a corrosion inhibition treatment and (C) treating the component with a corrosion inhibitor for magnesium, the present corrosion inhibitor is particularly preferably used as the corrosion inhibitor of the step (C).

It is preferable to add a step of washing with water in a next step of each of at least one step of (A), (B) and (C).

Furthermore, in a process for preparing a treated magnesium and/or magnesium alloy component comprising (1) deburring the magnesium and/or magnesium alloy component when required, (2) treating the component with a surface-treating agent, (2-1) washing with water, (3) treating the component with a pre-treating agent used before a corrosion inhibition treatment, (3-1) washing with water, (4) treating the component with a corrosion inhibitor for magnesium, (4-1) washing with water, (5) drying the component, (6) coating or plating the component, and (7) thereafter assembling the component, the present corrosion inhibitor is particularly preferably used as the corrosion inhibitor of the step (4).

The present surface treating agent contains a phosphate or an organic acid.

Examples of phosphates are ammonium salts and alkanolamine salts of orthophosphoric acid, condensed phosphoric acids or like phosphoric acids.

Examples of condensed phosphoric acids are metaphosphoric acids and polyphosphoric acids. Examples of metaphosphoric acids are trimetaphosphoric acid, tetrametaphosphoric acid, etc. Examples of polyphosphoric acids are pyrophosphoric acid, triphosphoric acid, tetraphosphoric acid and the like.

More specific examples of phosphates are ammonium primary phosphate, ammonium secondary phosphate, ammonium tertiary phosphate, monoethanolamine salt of phosphoric acid, diethanolamine salt of phosphoric acid, triethanolamine salt of phosphoric acid, isopropanolamine salt of phosphoric acid, ammonium salt of trimetaphosphoric acid, ammonium salt of tetrametaphosphoric acid, ethanolamine salt of tetrametaphosphoric acid, ammonium salt of triphosphoric acid, ammonium salt of tetraphosphoric acid, etc. These phosphates can be used singly, or at least two of them are usable in combination.

Among these, ammonium salts and alkanolamine salts of phosphoric acids are desirable since they have a suitable etching effect and are less likely to produce smut after cleaning. More desirable are ammonium salts of condensed phosphoric acids because they have high safety, permit facilitated waste water disposal, are capable of readily etching the surface of magnesium and/or magnesium alloy and are unlikely to etch to excess.

The ammonium salts of condensed phosphoric acids are known. Such a salt can be obtained, for example, by heating orthophosphoric acid (normal phosphoric acid) and urea for condensation. In this case, the reaction is conducted preferably under such a condition that the molar ratio of orthophosphoric acid to urea is 1:0.5 to 1:5. The surface treating agent may contain the unreacted materials in the reaction mixture, i.e., orthophosphoric acid and urea, and is usable without giving any problem to the advantage of the invention.

The phosphate is used usually in an amount of about 0.001 to about 90 wt. %, preferably about 0.5 to about 50 wt. %, more preferably about 1 to about 40 wt %. If the amount is greater than 50 wt. %, the surface of magnesium becomes colored black after cleaning, whereas if the amount is less than 0.5 wt. %, insufficient etching will result, failing to produce a full degreasing effect.

However, in case of the amount of the phosphate is less than 0.5 wt. % and relatively insufficient in etching effect and degreasing effect, when the treatment with the pre-treating agent used before a corrosion inhibition treatment is conducted in a next step, these defects can be remedied. Furthermore, in case of the amount of the phosphate is greater than 50 wt. % and the surface of magnesium becomes colored black, when the treatment with the pre-treating agent used before a corrosion inhibition treatment is conducted in a next step, these defects can be removed.

Examples of organic acids are carboxylic acids such as glycolic acid, citric acid, malic acid and tartaric acid. These organic acids are usually used in the form of an aqueous solution in a concentration of about 0.01 to about 50 wt %, preferably about 0.1 to about 10 wt %, or about 1 to about 5 wt %. If the concentration is less than 0.01 wt %, etching is insufficient so that the organic acid is frequently added to the treating solution. In the case of more than 50 wt %, excessive etching is brought about and is undesirable. Among these surface-treating agents, citric acid is especially desirable in view of occurrence of sludge in the treating solution and operational efficiency ensuing from the sludge.

By use of the surface-treating agent, occurrence of smut after treatment can be reduced, and the smut can be easily removed at the next step by the treatment with the pre-treating agent used before the corrosion inhibition treatment. The temperature is approximately room temperature which is sufficient to attain the desired etching effect. It is about 30 to about 50° C., preferably about 40° C. The ensuing smut can be easily removed by the treatment at the next step.

The surface-treating agent to be used in the invention may contain a surfactant or like additives to an extent which does not impair the effect of phosphate or organic acid.

The pre-treating agent used before the corrosion inhibition treatment which is described in WO 01/83849 is employable in the above-mentioned process.

Examples of the pre-treating agent used before a corrosion inhibition treatment are alkanolamines such as monoethanolamine, diethanolamine, triethanolamine, monoisopropanolamine, diisopropanolamine and triisopropanolamine; aliphatic amines such as methylamine, ethylamine and cyclohexylamine; aliphatic diamines such as 1,3-bis(aminomethyl)cyclohexane and ethylenediamine; ammonium salts such as tetramethylammonium hydroxide, tetraethylammonium hydroxide and tetramethylammonium nitrate; and cyclic amines such as 1,8-diazabicyclo[5.4.0]-7-undecene (DBU), 1,5-diazabicyclo[4.3.0]-5-nonene (DBN), 1-aminopyrrolidine and morpholine, ammonia, hydrazine, alkali metal hydroxides such as sodium hydroxide and potassium hydroxide and alkali metal salts of silicic acid such as sodium orthosilicate, potassium orthosilicate, sodium metasilicate and potassium metasilicate. These pre-treating agents can be used singly or in combination of at least two of them at the same time. Among these preferable are alkali metal hydroxides such as sodium hydroxide and potassium hydroxide.

The concentration of the pre-treating agent is about 0.01 to about 50 wt. %, preferably about 0.1 to about 30 wt. %, more preferably about 1 to about 20 wt. %. The pre-treating agent is an agent used before a corrosion inhibition treatment, and can be applied by spraying, coating with a spray or roll coater or impregnation with use of a treating bath. The pre-treating agent is used preferably after heating at 0 to 90° C., preferably about 20 to about 80° C., more preferably about 40 to about 70° C.

The smut occurring due to surface-treatment at the preceding step can be removed by the treatment with the pre-treating agent used before the corrosion inhibition treatment, resulting in improvements of corrosion inhibitory effect and coating adhesiveness achievable later.

After treatment with the corrosion inhibitor of the invention, the treated article is preferably washed with water. The coating adhesiveness is enhanced by addition of the step of washing with water. Hence it is preferred.

### BEST MODE OF CARRYING OUT THE INVENTION

Although the invention will be described in more detail below with reference to examples and test examples, the invention is not limited to the examples. The parts are by weight.

### EXAMPLE 1

Five parts of 3-mercapto-1,2,4-triazole was added to deionized water to give 100 parts of a solution. The solution was diluted 10-fold with deionized water to obtain a corrosion inhibitor (1).

### EXAMPLE 2

Five parts of 3-mercapto-1,2,4-triazole and 3 parts of monoisopropanolamine were added to deionized water to give 100 parts of a solution. The solution was diluted 10-fold with deionized water to obtain a corrosion inhibitor (2).

### EXAMPLE 3

Five parts of 3-hydroxy-1,2,4-triazole and 4 parts of monoisopropanolamine were added to deionized water to give 100 parts of a solution. The solution was diluted 10-fold with deionized water to obtain a corrosion inhibitor (3).

### EXAMPLE 4

2.5 parts of 3,5-dimethylpyrazole was added to deionized water to give 100 parts of a solution. The solution was diluted 5-fold with deionized water to obtain a corrosion inhibitor (4).

### EXAMPLE 5

Five parts of 3-methyl-5-hydroxypyrazole was added to deionized water to obtain 100 parts of a solution. The solution was diluted 10-fold with deionized water to obtain a corrosion inhibitor (5).

### EXAMPLE 6

One part of 3-hydroxy-1,2,4-triazole, 5 parts of Laol XA60/50 (Lion Corp., nonionic surfactant), 2.5 parts of Pionin-C (Takemoto Fats and Oils Co., Ltd., amphoteric surfactant) and 0.5 part of Tetoronic TR 913R (Asahidenka Co., Ltd., defoaming agent) were added to 50 parts of deionized water. The solution was adjusted to a pH of 7.0 with potassium hydroxide, and deionized water was added to give 100 parts of an aqueous solution. The aqueous solution was diluted 5-fold with deionized water to obtain a corrosion inhibitor (6).

### EXAMPLE 7

Two parts of 4-amino-1,2,4-triazole was added to deionized water to give 100 parts of a solution. The solution was diluted 10-fold with deionized water to obtain a corrosion inhibitor (7).

### COMPARATIVE EXAMPLE 1

Five parts of benzotrizole, and 2 parts of monoisopropanolamine were added to deionized water to give 100 parts of a solution. The solution was diluted 10-fold with deionized water to obtain a comparative corrosion inhibitor (1).

### COMPARATIVE EXAMPLE 2

Five parts of 3-mercapto-1,2,4-triazole, 5 parts of p-tert-butyl benzoic acid and 10 parts of monoisopropanolamine were added to deionized water to give 100 parts of a solution. The solution was diluted 10-fold with deionized water to obtain a comparative corrosion inhibitor (2).

### COMPARATIVE EXAMPLE 3

Five parts of 1,2,4-triazole, and 2 parts of monoisopropanolamine were added to deionized water to give 100 parts of a solution. The solution was diluted 10-fold with deionized water to obtain a comparative corrosion inhibitor (3).

### COMPARATIVE EXAMPLE 4

Five parts of 1,2,3-triazole, and 1 part of monoisopropanolamine were added to deionized water to give 100 parts of a solution. The solution was diluted 10-fold with deionized water to obtain a comparative corrosion inhibitor (4).

### COMPARATIVE EXAMPLE 5

2.5 parts of 3,5-dimethylpyrazole, 2.5 parts of p-tert-butyl benzoic acid and 5 parts of monoisopropanolamine were added to deionized water to give 100 parts of a solution. The solution was diluted 5-fold with deionized water to obtain a comparative corrosion inhibitor (5).

### REFERENCE EXAMPLE 1

Orthophosphoric acid was mixed with urea at a mole ratio of 1:2 and the mixture was reacted for 2 hours at 150 to 160° C to obtain condensed ammonium phosphate. The condensed ammonium phosphate contains unreacted urea and orthophosphoric acid. Deionized water was added to the obtained condensed ammonium phosphate to obtain about 16% (w/w) aqueous solution of condensed ammonium phosphate which was used as a surface-treating agent 1.

### REFERENCE EXAMPLE 2

Three parts of citric acid was added to deionized water to obtain 100 parts of a solution which was used as a surface-treating agent 2.

### TEST EXAMPLE 1

Molded plates (3×15×0.2 cm) were used as test pieces. The molded plates were produced from magnesium alloy AZ91D (containing 90% of magnesium, 9% of aluminum, and 1% of zinc) using a die casting machine wherein the die was coated with a release agent (Caster Ace 225, product of Nichibei Co., Ltd.).

The molded plates were immersed in the surface-treating agent 1 of Reference Example 1 under ultrasonic waves at room temperature for 1 minute, washed with water under aeration at room temperature for 1 minute, immersed in 10% (w/w) aqueous solution of potassium hydroxide at 60° C. under ultrasonic waves for 10 minutes, washed with water under aeration at room temperature for 1 minute, immersed in the corrosion inhibitor (6) of Example 6 at 60° C. under ultrasonic waves for 10 minutes, washed with water under aeration at room temperature for 1 minute, immersed in the corrosion inhibitor (1) of Example 1 at room temperature for 1 minute, washed with water at room temperature for 1 minute, and dried at 150° C. for 30 minutes to obtain a test piece (1).

Test pieces (2) and (3), and comparative test pieces (1), (2), (3) and (4) were obtained in the same manner as above by using the corrosion inhibitor (2) of Example 2, the corrosion inhibitor (3) of Example 3, the comparative corrosion inhibitor (1) of Comparative Example 1, the comparative corrosion inhibitor (2) of Comparative Example 2, the comparative corrosion inhibitor (3) of Comparative Example 3, and the comparative corrosion inhibitor (4) of Comparative Example 4 in place of the corrosion inhibitor (1) used in the foregoing treatments.

(Salt Spray Test)

A 5% (w/w) aqueous solution of sodium chloride was sprayed at 35° C. for 8 hours and 24 hours onto the test pieces (1) to (3) and the comparative test pieces (1) to (4), respectively. Then the test pieces were checked for corrosion.

The degree of corrosion was expressed in the ratio of corroded area per unit area.

TABLE 1

| | 8 hours later | 24 hours later |
|---|---|---|
| Test pieces (1) | 0% | 0% |
| Test pieces (2) | 0% | 0% |
| Test pieces (3) | 0% | 0% |
| Comparative test pieces (1) | 3% | 5% |
| Comparative test pieces (2) | 0% | 0% |
| Comparative test pieces (3) | 2% | 5% |
| Comparative test pieces (4) | 0% | 1% |

(Measurement of Electric Resistance)

The electric resistance of each of test pieces (1), (2), and (3) and comparative test pieces (2) and (4) was measured at desired three points (triplicate) on its surface using a contact resistance meter, Loresta MP (Mitsubishi Chemical Corporation, probe: two-probe system) . The results showed electric resistances of 0.3 ohm or less.

(Adhesion Test)

Each of test pieces (1), (2) and (3) and comparative test piece (2) was coated with a primer (Magnam Primer Gray HB 8655, product of Musashi Toryo Co., Ltd.) (frequency of application, once; coating film thickness, 18 to 20 μm) and baked at 160° C. for 20 minutes. Then a top coat (Armer Top Green Metallic AT20-1087, Musashi Toryo Co., Ltd.) was applied (frequency of application, once; coating film thickness, 13 to 15 μm), and baked at 160° C. for 20 minutes. Using each test piece, the primary and secondary adhesion tests were carried out.

The primary adhesion test was conducted by making cross-cuts (1 mm in each side of checkerboard squares, 100 squares in total) on the test pieces 1 day (24 hours) after application of the top coat. An adhesive cellophane tape was completely adhered to each test piece along the cut portion and thereafter peeled off instantaneously. The test pieces were then checked for the number of square coatings left after separation of the tape.

The secondary adhesion test was conducted by immersing each test piece in warm water at 60° C. for 4 hours after application of the top coat and the same procedure as in the primary adhesion test was repeated immediately after draining off the test piece.

The results are shown in Table 2. The table indicates that the coating adhesiveness was insufficient in use in combination with aromatic carboxylic acid.

TABLE 2

| | Primary | Secondary |
|---|---|---|
| | adhesion test | adhesion test |
| Test pieces (1) | 100/100 | 100/100 |
| Test pieces (2) | 100/100 | 100/100 |
| Test pieces (3) | 100/100 | 100/100 |
| Comparative test pieces (1) | 100/100 | 70/100 |

### TEST EXAMPLE 2

The same molded plates as in Test Example 1 were used.

The molded plates were immersed in isopropyl alcohol, and then immersed in the surface-treating agent 1 of Reference Example 1 under ultrasonic waves at room temperature for 1.5 minutes, washed with water under aeration at room temperature for 1 minute, immersed in 2% (w/w) aqueous solution of potassium hydroxide at 60° C. under ultrasonic waves for 10 minutes, washed with water under aeration at room temperature for 1 minute, immersed in the corrosion inhibitor (6) of Example 6 at 60° C. under ultrasonic waves for 5 minutes, washed with water under aeration at room temperature for 1 minute, immersed in the corrosion inhibitor (2) of Example 2 at room temperature for 1 minute, washed with water at room temperature for 1 minute, and dried at 150° C. for 20 minutes to obtain a test piece (4).

Comparative test pieces (5) was obtained in the same manner as above by using the comparative corrosion inhibitor (4) of Comparative Example 4 in place of the corrosion inhibitor (2) used in the above treatments.

A coating composition (Magtite, Kuboko Paint Co., Ltd.) was applied to each of test pieces (4) and comparative test piece (5) (frequency of application, once; coating film thickness, 15 to 20 μm) and baked at 160° C. for 20 minutes. Using each test piece, the secondary adhesion test was carried out.

TABLE 3

| | Secondary adhesion test |
|---|---|
| Test pieces (4) | 100/100 |
| Comparative test pieces (5) | 72/100 |

### Test Example 3

(Production 1 of Test Piece)

Molded plates (3×15×0.2 cm) were used as test pieces. The molded plates were produced from magnesium alloy AZ91D (containing 90% of magnesium, 9% of aluminum, and 1% of zinc) using a die casting machine wherein the die was coated with a release agent (Caster Ace 225, product of Nichibei Co., Ltd.).

The molded plates were immersed in the surface-treating agent 1 of Reference Example 1 under ultrasonic waves at room temperature for 1 minute, washed with water under aeration at room temperature for 1 minute, immersed in 10% (w/w) aqueous solution of potassium hydroxide at 60° C. under ultrasonic waves for 10 minutes, washed with water under aeration at room temperature for 1 minute, immersed in the corrosion inhibitor (6) of Example 6 at 60° C. under ultrasonic waves for 10 minutes, washed with water under aeration at room temperature for 1 minute, immersed in the corrosion inhibitor (4) of Example 4 at room temperature for 1 minute, washed with water under aeration at room temperature for 1 minute, and dried at 150° C. for 30 minutes to obtain a test piece (5).

Test pieces (6) and comparative test pieces (6) were obtained in the same manner as above by using the corrosion inhibitor (5) of Example 5 and the comparative corrosion inhibitor (5) of Comparative Example 5 in place of the corrosion inhibitor (4) used in the above treatments.

(Production 2 of Test Piece)

Use was made of the molded plates used in production 1 of test pieces.

The molded plate was immersed in a 2% (w/w) aqueous solution of potassium hydroxide and a 0.1% (w/w) aqueous solution of Noigen SD-80 (Daiichi Kogyo Seiyaku Co., Ltd., nonionic surfactant) at 60° C. for 5 minutes under supersonic waves, washed with water under aeration at room temperature for 1 minute, immersed in the surface-treating agent 2 of Reference Example 2 at 30° C. for 1 minute, washed with water under aeration at room temperature for 1 minute, immersed in a 5% (w/w) aqueous solution of potassium hydroxide at 60° C. for 5 minutes under supersonic waves, washed with water under aeration at room temperature for 1 minute, immersed in the corrosion inhibitor (7) of Example 7 at 60° C. for 5 minutes under supersonic waves, washed with water under aeration at room temperature for 1 minute, immersed in the corrosion inhibitor (4) of Example 4 at 25° C. for 1 minute, washed with water under aeration at room temperature for 1 minute, and dried at 150° C. for 20 minutes to obtain a test piece (7).

The test piece (7) thus obtained had an appearance excellent in metallic luster.

(Salt Spray Test)

A 5% (w/w) aqueous solution of sodium chloride was sprayed at 35° C. for 8 hours and 24 hours onto the test pieces (5) to (7) and the comparative test pieces (6), respectively. Then the test pieces were checked for corrosion. The degree of corrosion was expressed in the ratio of corroded area per unit area. Table 4 shows the results.

TABLE 4

| | 8 hours later | 24 hours later |
|---|---|---|
| Test pieces (5) | 0% | 0% |
| Test pieces (6) | 0% | 0% |
| Test pieces (7) | 0% | 0% |
| Comparative test pieces (6) | 0% | 0% |

(Measurement of Electric Resistance)

The electric resistance of each of test pieces (5), (6) and (7) and comparative test pieces (6) was measured at desired three points (duplicate) on its surface using a contact resistance meter, Loresta MP (Mitsubishi Chemical Corporation, probe: two-probe system). The results showed electric resistances of 0.2 ohm or less.

(Adhesion Test)

Each of test pieces (5) and (7) and comparative test piece (6) was coated with a primer (Magnam Primer Gray HB 8655, product of Musashi Toryo Co., Ltd.) (frequency of application, once; coating film thickness, 18 to 20 μm) and baked at 160° C. for 20 minutes. Then a top coat (Armer Top Green Metallic AT20-1087, Musashi Toryo Co., Ltd.) was applied (frequency of application, once; coating film thickness, 13 to 15 μm), and baked at 160° C. for 20 minutes. Using each test piece, the primary and secondary adhesion tests were carried out.

The primary adhesion test was conducted by making cross-cuts (1 mm in each side of checkerboard squares, 100 squares in total) on the test pieces 1 day (24 hours) after application of the top coat. An adhesive cellophane tape was completely adhered to each test piece along the cut portion and thereafter peeled off instantaneously. The test pieces were then checked for the number of square coatings left after separation of the tape.

The secondary adhesion test was conducted by immersing each test piece in warm water at 60° C. for 4 hours after application of the top coat and the same procedure as in the primary adhesion test was repeated immediately after draining off the test piece.

The results are shown in Table 5. The table indicates that the coating adhesiveness was insufficient in use in combination with aromatic carboxylic acid.

TABLE 5

| | Primary | Secondary |
|---|---|---|
| | adhesion test | adhesion test |
| Test pieces (5) | 100/100 | 100/100 |
| Test pieces (7) | 100/100 | 100/100 |
| Comparative test pieces (6) | 100/100 | 90/100 |

### INDUSTRIAL APPLICABILITY

According to the invention, it is possible to provide a corrosion inhibitor which has a high corrosion inhibitory effect against magnesium and/or magnesium alloy and which is excellent in coating adhesiveness, and a process for producing components or parts made of magnesium and/or magnesium alloy using the corrosion inhibitor.

1. A corrosion inhibitor for magnesium and/or magnesium alloy containing, as an effective component, a least one kind of compound selected from the group consisting of a compound of the formula (1) and a compound of the formula (2) and salts thereof 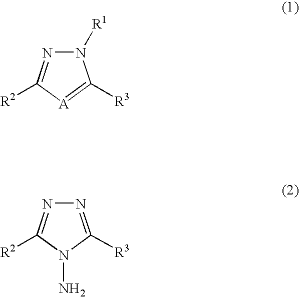
wherein R¹ is a hydrogen atom, or C₁₋₄ alkyl, R² is a hydrogen atom, C₁₋₄ alkyl, mercapto or hydroxy, R³ is a hydrogen atom, C₁₋₄ alkyl or hydroxy, A is —N═ or —C(R⁴)═, R⁴ is a hydrogen atom or amino.

2. A corrosion inhibitor for magnesium and/or magnesium alloy as defined in claim 1 wherein, in the formula (1), R¹ is a hydrogen atom, R² is mercapto, R³ is a hydrogen atom, and A is —N═.

3. A corrosion inhibitor for magnesium and/or magnesium alloy as defined in claim 1 wherein, in the formula (1), R¹ is a hydrogen atom, R² is C₁₋₄ alkyl, R³ is C₁₋₄ alkyl or hydroxy, A is —C(R⁴)═, and R⁴ is a hydrogen atom.

4. A corrosion inhibitor for magnesium and/or magnesium alloy as defined in claim 1 wherein, in the formula (1), R¹ is a hydrogen atom, R² is C₁₋₄ alkyl, R³ is C₁₋₄ alkyl, A is —C(R⁴)═, and R⁴ is a hydrogen atom.

5. A corrosion inhibitor for magnesium and/or magnesium alloy as defined in claim 1 wherein, in the formula (2), R² is hydrogen atom, and R³ is a hydrogen atom.

6. A corrosion inhibitor for magnesium and/or magnesium alloy as defined in claim 1 wherein the compound of the formulas (1) and (2) is 3-hydroxy-1,2,4-triazole, 3-mercapto-1,2,4-triazole, 4-amino-1,2, 4-triazole, 3, 5-dimethylpyrazole or 3-methyl-5-hydroxypyrazole.

7. A process for preparing a treated magnesium and/or magnesium alloy component comprising (A) treating a magnesium and/or magnesium alloy component with a surface-treating agent, and (C) treating the component with a corrosion inhibitor for magnesium, wherein the corrosion inhibitor of claim 1 is used as such corrosion inhibitor.

8. A process for preparing a treated magnesium and/or magnesium alloy component comprising (A) treating the magnesium and/or magnesium alloy component with a surface-treating agent, (B) treating the component with a pre-treating agent used before a corrosion inhibition treatment and (C) treating the component with a corrosion inhibitor for magnesium, wherein the corrosion inhibitor of claim 1 is used as such corrosion inhibitor.

9. A process for preparing a treated magnesium and/or magnesium alloy component as defined in claim 7 wherein the step of treatment with a corrosion inhibitor for magnesium is repeated at least twice.

10. A process as defined in claim 7 wherein a step of washing with water is added in a next step of each of at least one step of (A), (B) and (C).

11. A process for preparing a treated magnesium and/or magnesium alloy component comprising (1) deburring the magnesium and/or magnesium alloy component when required, (2) treating the component with a surface-treating agent, (2-1) washing with water, (3) treating the component with a pre-treating agent used before a corrosion inhibition treatment, (3-1) washing with water, (4) treating the component with a corrosion inhibitor for magnesium, (4-1) washing with water, (5) drying the component, (6) coating or plating the component, and (7) thereafter assembling the component, wherein the corrosion inhibitor of claim 1 is used as the above corrosion inhibitor for magnesium.

12. A process for preparing a magnesium and/or magnesium alloy component as defined in claim 11 wherein the step of treatment with a corrosion inhibitor for magnesium is repeated at least twice.

13. A process for preparing a treated magnesium and/or magnesium alloy component as defined in claim 8 wherein the step of treatment with a corrosion inhibitor for magnesium is repeated at least twice.

14. A process as defined in claim 8 wherein a step of washing with water is added in a next step of each of at least one step of (A), (B) and (C).

15. A process as defined in claim 9 wherein a step of washing with water is added in a next step of each of at least one step of (A), (B) and (C).

16. A process as defined in claim 13 wherein a step of washing with water is added in a next step of each of at least one step of (A), (B) and (C).
